(19) United States
(12) Patent Application Publication
(10) Pub. No.: US 2021/0212518 A1
(43) Pub. Date: Jul. 15, 2021

(54) HERB GRINDER

(71) Applicant: Cordier, Paris (FR)

(72) Inventors: Arnaud Christodoulou, Paris (FR); Leonard Pallardy, Champigny-Sur-Marne (FR)

(21) Appl. No.: 17/149,281

(22) Filed: Jan. 14, 2021

Related U.S. Application Data
(60) Provisional application No. 62/960,945, filed on Jan. 14, 2020.

(51) Int. Cl. A47J 42/28; A47J 42/30

(52) U.S. Cl. CPC A47J 42/28; A47J 42/30

(57) ABSTRACT

This invention concerns a herb grinder, comprising two cutting half-chambers with complementary curved inner forms configured to be coupled to each other, each curved inner form having a curved inner surface and a plurality of protrusions on the curved inner surface, forming a cutting area, each protrusion extending continuously along the radial direction and having a length equivalent to at least a part of the radius length, the protrusions in cutting areas of the two complementary curved inner surfaces being aligned to push and to cut the herb, when the two half-chambers are coupled to realize a relative movement to each other.

### CROSS-REFERENCE TO RELATED APPLICATION

This application claims the benefit under 35 U.S.C. § 119(e) of U.S. Provisional Patent Application Ser. No. 62/960,945, filed Jan. 14, 2020, the disclosure of which is hereby incorporated herein in its entirety by this reference.

### TECHNICAL FIELD

This invention relates generally to grinders, and more particularly has referred to a grinder specifically designed for cutting herbs.

### BACKGROUND

In the prior art WO2014/100773, the grinder is in the form of a sheet with a series of spaced-apart parallel notches of elongated shape. No matter to use one sheet alone or two sheets facing each other, it is difficult to delimit the movement of the herb and to use all the surface of the cutting area efficiently.

In the U.S. Pat. No. 9,510,709, the herb chopper includes a chopping device, such as an upper chopper and lower chopper, which can be fitted on a container. The lower chopper includes the teeth on an upper surface thereof, while the upper chopper includes the teeth on a lower surface thereof. The teeth of the upper chopper and lower chopper are staggered so as to not contact each other as the upper chopper rotates relative to the lower chopper. The teeth on the choppers rotate and slide past each other to chop the herb leaves until the herbs reach a size small enough to fit through the dispensing holes.

### BRIEF SUMMARY

In order to increase the efficiency of cutting, the present invention introduces a concept of a cutting area by using two cutting half-chambers with complementary inner forms to effectively delimit the herb inside the cutting area. The two cutting half-chambers are coupled to each other and rotate relative to each other coaxially, and have aligned cutting areas made of protrusions extending along the radial direction. The shape and distribution of the protrusions make sure that all the herb inside the cutting area is cut without any spared space inside the cutting area.

The present invention proposes a concept of using complementary inner forms of two half-chambers with the aligned protrusions along the radial direction, which gives a similar effect of installing many scissors distributed around the whole inner surfaces of the cutting area. Comparing with the prior art with a large number of teeth extending vertically, the present invention provides a solution with cutting areas extending horizontally, which saves the space and is much more compact. In addition, the prior art uses long teeth to realize the cutting effect. The longer the teeth, the easier they can be broken. However, the shorter teeth are not effective in the cutting effect. The present invention uses the protrusions as cutting element, which are mechanically much more resistive than the long teeth. In the prior art, each half-chamber has a specific pattern of the teeth distribution in order to realize the scissor effect but to avoid the collision of the teeth from different half-chamber, which are complicated in the fabrication process. The present invention presents protrusion extending continuously along the radial direction to facilitate the fabrication. Finally, the present invention minimizes the useful components to only two pieces of two half-chambers to realize the function of pushing, cutting and collecting the herbs. These two half-chambers have complementary curved inner forms with surfaces, which aims at optimizing the pressure distribution between the two complementary curved inner surfaces.

The present invention concerns a herb grinder, comprising:
Two cutting half-chambers with complementary curved inner forms configured to be coupled to each other,
each curved inner form having a spherical inner surface and a plurality of protrusions on the spherical inner surface, forming a cutting area,
each protrusion extending continuously along the radial direction and having a length equivalent to at least a part of the radius length of the spherical surface,
the inclination angles of the protrusions on the spherical inner surfaces being complementary between the two half-chambers,
The protrusions in cutting areas of the two complementary curved inner surfaces being aligned to push and to cut the herb, when the two half-chambers are coupled to realize a relative movement to each other.

The herb grinder has at least one of the following features, either separately or in combination, so far as they are compatible with each other.
the protrusions are cutting blades, or grooves with acute or obtuse angles,
the protrusions have a shape selected from the straight lines, curved lines and/or wavy lines,
the protrusions have an inclined angle between 5°-90° relative to the inner surface of the cutting half-chamber,
the two cutting half-chambers are made from a material selected from the group consisting of plastic, metal, wood and glass,
each cutting half-chamber has a magnet with opposite polarity so that the two half-chambers kept together by the magnets,
at least one of the cutting half-chamber have holes on the surface.

The herb grinder can further comprises:
A pollen sifter having a pollen sifter screen, the pollen sifter configured to be coupled to the cutting half-chamber with holes on the surface and
A sift catcher configured to be coupled to the pollen sifter to collect sift that passes through the pollen sifter screen.

The following detailed description gives illustrative but non-limitative examples, which are exemplary in nature and are not intended to limit the scope, applicability, or configuration of the invention in any way. Rather, the following description provides some practical illustrations for various embodiments of each component, which can be combined together and those skilled in the art will recognize easily these alternatives.

### BRIEF DESCRIPTION OF DRAWINGS

FIG. 1 is a sectional view of a cutting chamber comprising two cutting half-chambers presented either separately or coupled together.

FIG. 2 is a top view of the half-chambers from the side of the curved inner surfaces.

FIG. 3 is a sectional view of another embodiment of the cutting chamber comprising two cutting half-chambers presented either separately or coupled together.

FIG. 4 is a sectional view of the different shapes of the protrusions.

FIGS. 5a-5e show different embodiments of the protrusion patterns on the curved inner surface of the half-chamber.

FIGS. 6a-6c show other alternative embodiments of the protrusion patterns on the curved inner surface of the half-chamber.

FIG. 7a is a top view of the half-chambers from the side of the curved inner surfaces to illustrate the holes.

FIG. 7b is a top view of a pollen sifter.

FIG. 8 is a sectional view of an assembly of the herb grinder.

FIGS. 9a-9c show different embodiments of the assembly of the herb grinder.

### DETAILED DESCRIPTION

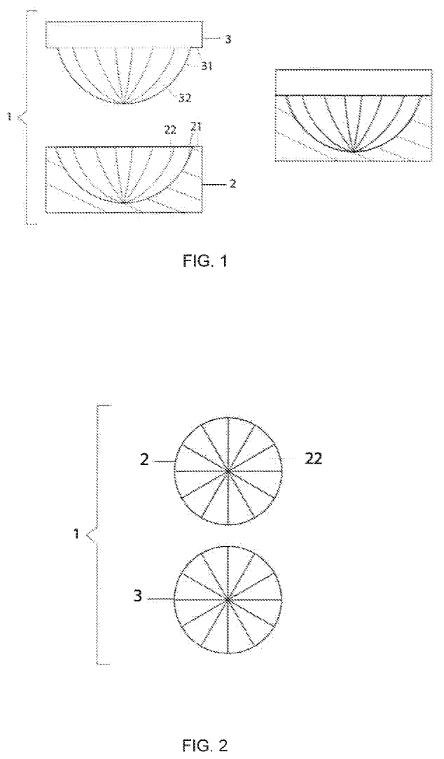

Referring now to the drawings, the FIG. 1 presents a side sectional views of a herb grinder 1 with two cutting half-chambers 2 and 3 presented separately or coupled together. The two cutting half-chambers have complementary spherical forms. On the inner surface of each half-chamber, there are a plurality of protrusions 22, 32 forming a cutting area. The FIG. 2 is a top view of the herb grinder 1 with two half-chambers 2 and 3 seen from the side of the inner surfaces. The protrusions in this particular embodiment are cutting blades positioned in a pattern of a divergent star extending from the center point to the circumference of the sphere.

When the complementary forms of the two half-chambers are coupled to each other, the cutting areas of the two half-chambers are aligned. The herb is placed into the cutting chamber and between the two aligned cutting areas for cutting. When the two half-chambers are rotated relatively to each other, or only one half-chamber is rotated relatively to the other one, the cutting effect occurs as a result of the relative movement between the cutting blades on the two half-chambers.

For those skilled in the art, the size, shape and arrangement of the protrusions can vary regarding to the raw material (herbs, spices, dry flowers) so as to provide a suitable cutting area on the inner surface of the half-chambers to obtain a required cutting effect. The size and shape of the half-chambers can also vary. For those skilled in the art, it is easy to combine the different shape of half-chamber with different embodiments of the protrusions.

In the FIG. 1, the inner surface 21 of half-chamber 2 presents a concave spherical form, while the inner surface 31 of the half-chamber 3 presents a corresponding convex spherical form, so that the two half-chambers can be coupled together with the cutting areas facing each other. The protrusions at each cutting area are presented as curved lines along the spherical surface.

The FIG. 3 shows another possibility of the two half-chambers in conical form. At the left side and the right side are respectively the side sectional views of two separated and coupled half-chambers having complementary conical forms. On the inner surface of each half-chamber, there are a plurality of protrusions presented as straight titled lines along the conical surface.

It is also possible to have the two half-chambers presenting flat inner surfaces with the protrusions extending as straight lines on the flat surface to form a cutting area.

Among the three forms, the spherical form has the largest cutting area, the conical form is in the middle, and the flat form has the smallest cutting area.

The conical form is adapted especially well for grinding the grains and the seeds, because the substance of the grains and seeds are rigid. When they are placed inside a grinder with a conical form, the grains disperse naturally along the conical surface. In contrary, the spherical form works much better in cutting the herbs, because of its largely horizontally extended surface. The substance of the herbs is much more flexible than the grains or seeds, so that the herbs can be spread on a more horizontally extended surface. If the herbs are put onto a conical surface, the pressure will lead to a heterogeneous distribution, which deteriorates the quality of cutting.

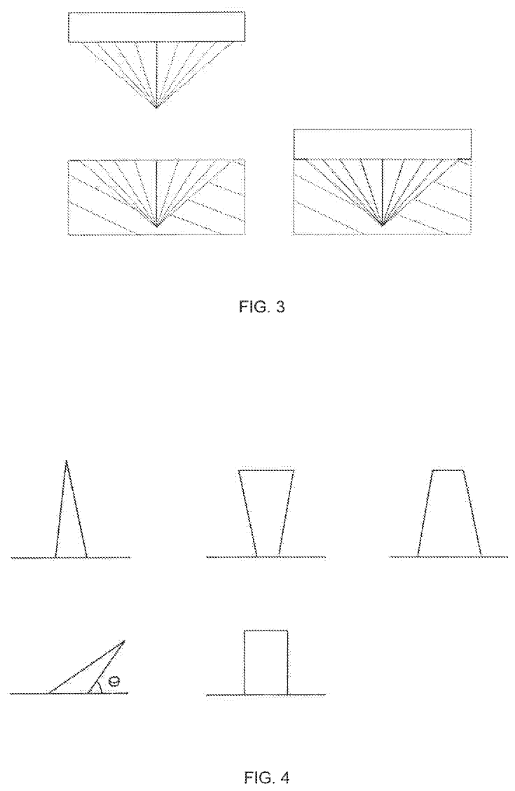

The FIG. 4 shows the different shapes of the protrusions. The edges of the protrusions provide a cutting effect when the two half-chambers are coupled and rotate relative to each other, or only one half-chamber is rotated relatively to the other one. The cutting effect occurs as a result of reciprocal movement of the herbs between the cutting areas. In a particular embodiment, the protrusions are cutting blades, which have sharp endings. It is also possible to use the grooves, which are notches of elongated rectangular shapes. The angles between the inner surface and the side wall of the notches are acute or obtuse. When the angle is acute, the cutting edge protrudes more, which results in an enhanced cutting effect. When the angle is obtuse, the cutting edge is blunter, which results in a reduced cutting effect.

The FIG. 4 also shows the different inclined angle theta of the protrusions relative to the inner surface of the cutting half-chamber, which can be in the range of 5°-90°.

For the properly-functioned cutting mechanism, the shape of the protrusions must be complementary between the two half-chambers. Consequently, upon mechanical actuation of the system, the edges of the protrusions will cut the herbs like a scissor blade. This is represented in FIG. 4 by the degree of inclination of the protrusion. For example, if the upper protrusion has an inclination of 45 degrees, the lower protrusion has an inclination equal to 180−45=135 degrees. In a general representation, the inclination angles of the protrusions on both of the spherical inner surfaces must be complementary between the two half-chambers, which means that when the inclination angle of the protrusions on one half-chamber is theta, the inclination angle of the protrusions on the other half-chamber is 180°-theta. In general, at the center region of the two half-chambers, there is some degree of tolerance, which means that the inclination angle of the protrusions on the other half-chamber can be plus or minus several degrees around 180°-theta degree.

In addition, the spherical form of the half-chamber requires that the edges of the protrusions are more acute in the center, and more obtuse towards the edge of the half-chamber.

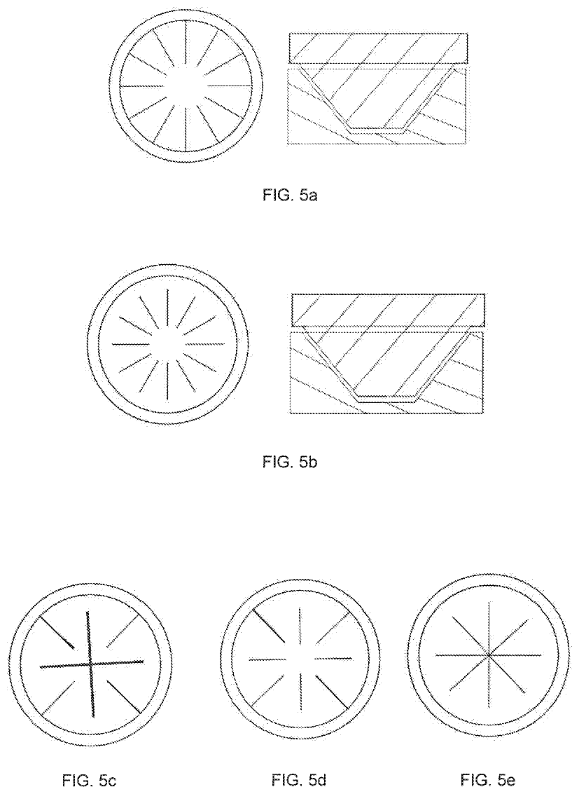

Another important characteristic of the present invention is that the protrusions extend continuously along the radial direction for a length equivalent to at least a part of the radius length, no matter what the size or shape of the protrusions. The FIG. 2 shows an example of a spoke formed cutting area that each protrusion extends continuously along the radial direction from the center point to the circumference over the full length of the radius. The FIG. 5 shows alternative embodiments of the protrusion patterns. The difference from the protrusions in the FIG. 2 is that the protrusions in the FIG. 5 have a length equivalent to only a part of the radius length but not the complete full radius length. The FIG. 5a shows a pattern with a center region without protrusion, and the protrusions extending from the edge of the center region to the circumference. At the left side is a top view, while at the right side is a sectional view of the two half-chambers coupled together. The FIG. 5b shows another pattern with a center region without protrusion and the protrusions ending before reaching the circumference. At the upper part is a top view, while at the lower part is a sectional view of the two half-chambers coupled together. The FIG. 5c shows a pattern with two types of protrusions: a first type of the protrusions crossing the center point but ending before reaching the circumference, while a second type of the protrusions extending from the circumference, but not reaching the center point. The FIG. 5d shows another pattern with two types of protrusions: a first type of the protrusions extending between a center region around but avoiding the center point and the circumference, while the other part of the protrusions only extending from the circumference and not touching the center point. The FIG. 5e shows a pattern of protrusions extending from the center point, but not reaching the circumference.

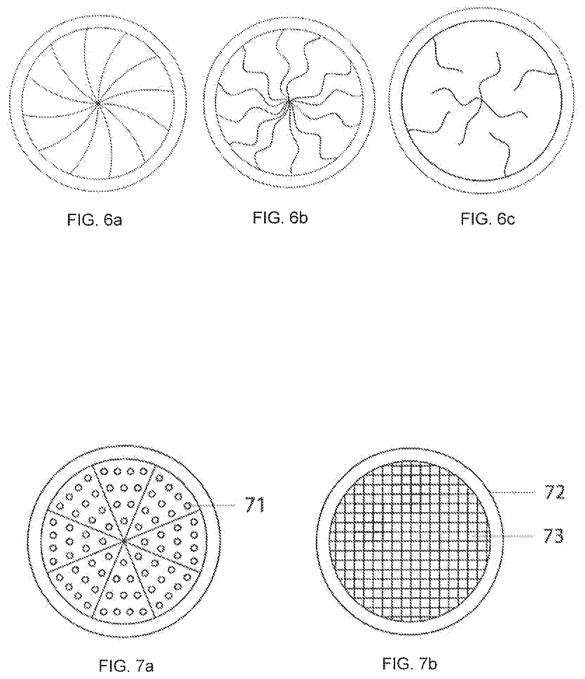

The above figures show the embodiments in which each protrusion is in the shape of a straight line. It is also possible to have the protrusions in the form of curved lines as shown in the FIG. 6a, or wavy lines in the FIG. 6b. For those skilled in the art, it is easily to combine the different shapes of the protrusions with the different patterns discussed before as the one shown in the FIG. 6c.

It is possible that none of the cutting chamber has holes so that the ground material stays between the two half chambers. Another possibility is to pass the ground herb out of the cutting chamber. In order to realize this function, at least one of the cutting half-chamber has holes 71 on the inner surface as shown in the FIG. 7a. The size of the holes is preferably between about 0.5 mm and 15 mm, with 4 mm being typical. Then the ground herb is filtered by a pollen sifter 72 having a pollen sifter screen 73 as shown in the FIG. 7b. The pollen sifter screen can, for example, be made from a porous material such as a mesh, or be constructed from a series of structural features, such as a series of bars or holes. The pollen sifter screen can be affixed or removably attached to the pollen sifter.

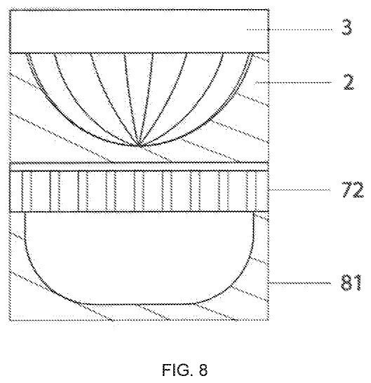

The FIG. 8 illustrates the assembly of the herb grinder. The cutting chamber is realized by coupling together the two half-chambers 2 and 3. The pollen sifter 72 is configured to be coupled to the cutting half-chamber with holes on its inner surface and a sift catcher 81 is configured to be coupled to the pollen sifter to collect sift that passes through the pollen sifter screen. In addition, the caps at the top and at the bottom can be added to close the herb grinder.

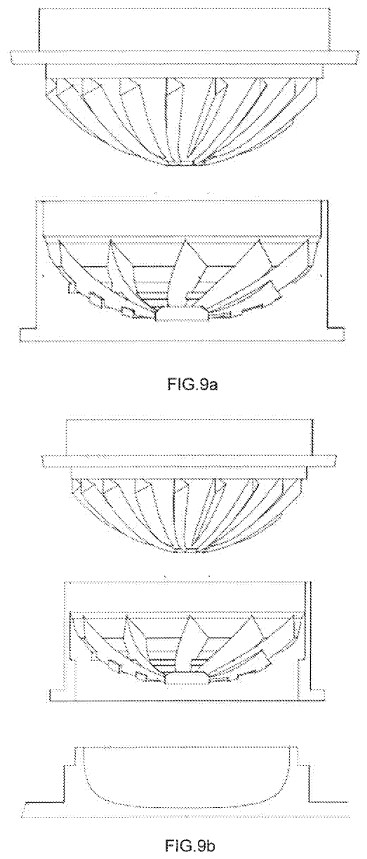

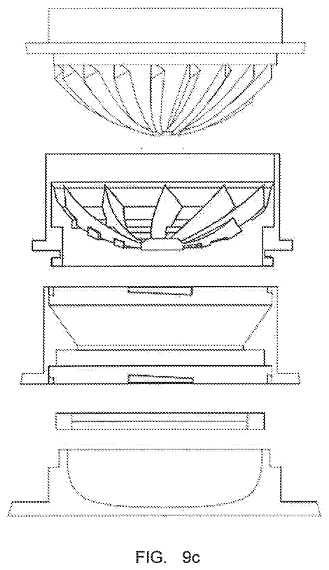

The FIG. 9 illustrates three more realistic technical drawings of the final products. The FIG. 9a shows an herb grinder composed of two half-chambers, with the protrusions drawn in a three-dimensional manner so that the shape edges of the protrusions are illustrated clearly. The FIG. 9b shows an herb grinder composed of the two half-chambers with an additional collection chamber for the ground herb. The FIG. 9c shows furthermore the supplementary pieces of a pollen sifter and a sift catcher on the basis of the herb grinder shown in the FIG. 9b.

In order to prevent the ground bits from adhering to the surface of the grinder and thereby reducing the effectiveness and service life of the grinder, and in order to make it easier to clean the grinder after each use, the grinder is preferably made of stainless steel. It is possible to coat a nonstick material on the surface, such as Teflon, so that the grinder can be easily washed and quickly cleaned. A frosted or brushed finish also may be applied to the surface of the grinder, if desired.

In all of the foregoing embodiments, the two cutting half-chambers can be made out of plastic, metal, wood, rock (granite) or glass, and combinations thereof. The depth of the protrusions is preferably between 0.005-20 mm. In addition, the density of the protrusions can vary depending on the materials to be ground. For example, pepper needs denser and sharper blades to be ground than the dried flowers.

Each element, such as the cutting half-chamber, pollen sifter, can have an axial magnet with opposite polarity so that they can be assembled together by the magnetic force. It is also possible to have mechanical accessories to couple and to assemble the elements.

In all of the foregoing embodiments, there are many ways of forming the protrusions. For example, using a CNC machine, mold stamping, laser cutting, 3D printing or water jetting to process the herb grinder surface. Another option is to use mask chemical corrosion which when processing, causes the bottom of the protrusions to be corroded and rough, which can enhance the grinding efficiency. The surface of the grinder also can be either smooth or rough, as desired. The holes can be formed by stamping or punching or by any other suitable means, and they can be formed in the surface before or after the protrusions have been formed.

The above described herb grinder can be used to cut all kinds of dry or fresh herbs and spices. A particular application is in the domain of cutting resin of the cannabis plant or hashish for hemp containing a federally legal amount of THC by dried biomass.

What is claimed is:

1. An herb grinder, comprising:
two cutting half-chambers with complementary curved inner forms configured to be coupled to each other;
each curved inner form having a spherical, but not conical, inner surface and a plurality of protrusions on the spherical inner surface, forming a cutting area;
each protrusion extending continuously along the radial direction and having a length equivalent to at least a part of the radius length of the spherical surface;
the inclination angles of the protrusions on both of the spherical inner surfaces being complementary between the two half-chambers to realize a cutting effect; and
the protrusions in cutting areas of the two complementary curved inner surfaces being aligned to push and to cut the herb, when the two half-chambers are coupled to realize a relative movement to each other.

2. The herb grinder of claim 1, wherein the protrusions are cutting blades, or grooves with acute or obtuse angles.

3. The herb grinder of claim 1, wherein the protrusions have a shape selected from the straight lines, curved lines and/or wavy lines.

4. The herb grinder of claim 1, wherein the protrusions have an inclined angle between 5°-90° relative to the inner surface of the cutting half-chamber.

5. The herb grinder of claim 1, wherein the two cutting half-chambers are made from a material selected from the group consisting of plastic, metal, wood and glass.

6. The herb grinder of claim 1, wherein each cutting half-chamber has a magnet with opposite polarity so that the two half-chambers kept together by the magnets.

7. The herb grinder of claim 1, wherein at least one of the cutting half-chamber have holes on the surface.

8. The herb grinder of claim 7, further comprising:
a pollen sifter having a pollen sifter screen, the pollen sifter configured to be coupled to the cutting half-chamber with holes on the surface; and
a sift catcher configured to be coupled to the pollen sifter to collect sift that passes through the pollen sifter screen.
